(19) United States
(12) Patent Application Publication
(10) Pub. No.: US 2020/0041982 A1
(43) Pub. Date: Feb. 6, 2020

(54) NUMERICAL CONTROLLER

(71) Applicant: Fanuc Corporation, Yamanashi (JP)

(72) Inventor: Yasushi Hayashi, Minamitsuru-gun (JP)

(73) Assignee: Fanuc Corporation, Yamanashi (JP)

(21) Appl. No.: 16/524,760

(22) Filed: Jul. 29, 2019

(30) Foreign Application Priority Data
Jul. 31, 2018 (JP) 2018-144169

(51) Int. Cl. G05B 19/4155; H04L 29/08

(52) U.S. Cl. CPC G05B 19/4155; G05B 2219/40183; H04L 67/141

(57) ABSTRACT

A numerical controller is configured to perform machining in accordance with a machine control program, establish a connection to a connecting destination node written in network connection information, and activate a processing program for accessing information relating to machining located at the connecting destination node. The numerical controller treats the machine control program and the network connection information as a pair.

### RELATED APPLICATIONS

The present application claims priority to Japanese Patent Application Number 2018-144169 filed Jul. 31, 2018, the disclosure of which is hereby incorporated by reference herein in its entirety.

### BACKGROUND OF THE INVENTION

### 1. Field of the Invention

The present invention relates to a numerical controller, and particularly to a numerical controller that has the function of analyzing network connection information contained in a machining program and establishing a connection to a network address.

### 2. Description of the Related Art

Conventionally, it has been complicated work to handle files on a network, such as files (hereinafter referred to as a related file) of a manual, CAD data, and the like that are used in relation to machining and referenced by an operator of the numerical controller as needed. To handle a related file, an operator has needed to activate software for performing file handling and designate the address on the network at which the related file is located using the software.

FIG. 1 is a diagram that illustrates processing necessary for browsing related files in a prior art technique.

A numerical controller (network address is 192.168.0.100) that an operator operates and PC1 (192.168.0.2), PC2 (192.168.0.3), and PC3 (192.168.0.4) that store various kinds of files are located on the same network. When an operator wishes to browse a file, the operator activates software having file browsing function, such as document browsing software, tool information management software, CAD drawing reference software, or machining information collecting software, on the numerical controller. The operator then designates the address of a network node (PC1, PC2, or PC3) at which the file to be is located and the file name with respect to the activated software. Then, the software accesses the designated network address, and acquires and displays the desired file. Thus, in the prior art technique, an operator needs to explicitly designate the location of a file to be browsed each time.

A prior art technique relating to a file call described in Japanese Patent Application Laid-Open No. 2008-204410 provides a numerical controller that can call a second program using an instruction command in a first program. However, this technique described in Japanese Patent Application Laid-Open No. 2008-204410 is a technique that calls another control program (machine control program containing parameters, tool data, and the like) from the inside of an NC program, and cannot meet demands to allow an operator to easily call related files scattered on a network when the operator needs the related files.

Specifically, in the prior art technique, in the case where a file on a network is called, an operator of a numerical controller needs to input and set a correct network address at which a file or data are located. For example, in the case where two or more related files are located on different network nodes, the operator needs to make settings for each related file. This work takes time and labor.

Moreover, an NC program and related files originally have close correspondence relationships. Conventionally, these correspondence relationships have been manually managed by an operator. For example, an NC program may have related files of a machining instruction, CAD data on a product drawing, and the like corresponding to the NC program. Whether the related files can be browsed by understanding the correspondence relationships between the NC program and the related files is up to the operator. Accordingly, there have been problems such as difficulty in accurately conveying the intention of the designer to an operator.

Moreover, every time the addresses of network nodes at which files are located are changed or added, settings on the referenced nodes needs to be changed on a numerical controller that has referenced these files. This work takes time and labor.

### SUMMARY OF THE INVENTION

The present invention has been made to solve the above-described problems, and an object of the present invention is to provide a numerical controller that has the function of analyzing network connection information contained in a machining program and establishing a connection to a network address.

A numerical controller according to one embodiment of the present invention includes: a machine control program execution section for performing machining in accordance with a machine control program; a network connection section for establishing a connection to a connecting destination node written in network connection information; and a processing program designation section for activating a processing program for accessing information relating to the machining located at the connecting destination node. The machine control program and the network connection information are treated as a pair.

The numerical controller may further include an NC program separation section for analyzing an NC program containing the machine control program and the network connection information and for separating the NC program into the machine control program and the network connection information.

The machine control program may be described, as property information, in an NC program file in which the machine control program is described, and the numerical controller may further include an NC program separation section for analyzing the NC program file and for separating the NC program file into the machine control program and the network connection information.

According to the present invention, a numerical controller that has the function of analyzing network connection information contained in a machining program and establishing a connection to a network address can be provided.

### BRIEF DESCRIPTION OF THE DRAWINGS

FIG. 1 is a diagram for explaining a prior art technique and problems.

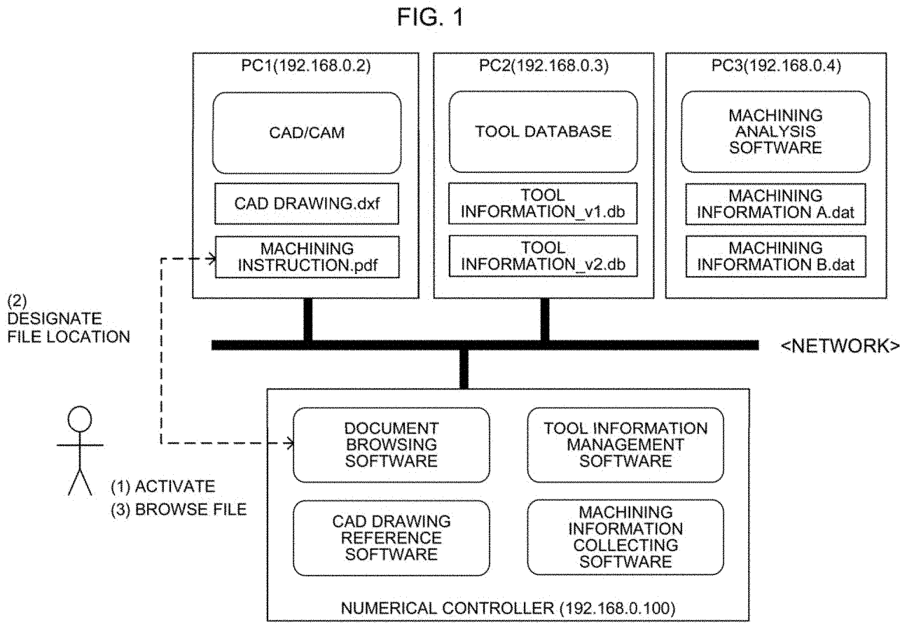

FIG. 2 is a diagram illustrating an example of the hardware configuration of a numerical controller.

FIG. 3 is a diagram illustrating an example of a functional configuration of an information processing system including a numerical controller.

FIG. 4 is a diagram illustrating one example of an NC program.

FIG. 5 is a diagram illustrating the operation of the numerical controller.

FIG. 6 is a diagram illustrating one modified example of the numerical controller.

### DETAILED DESCRIPTION OF THE PREFERRED EMBODIMENT

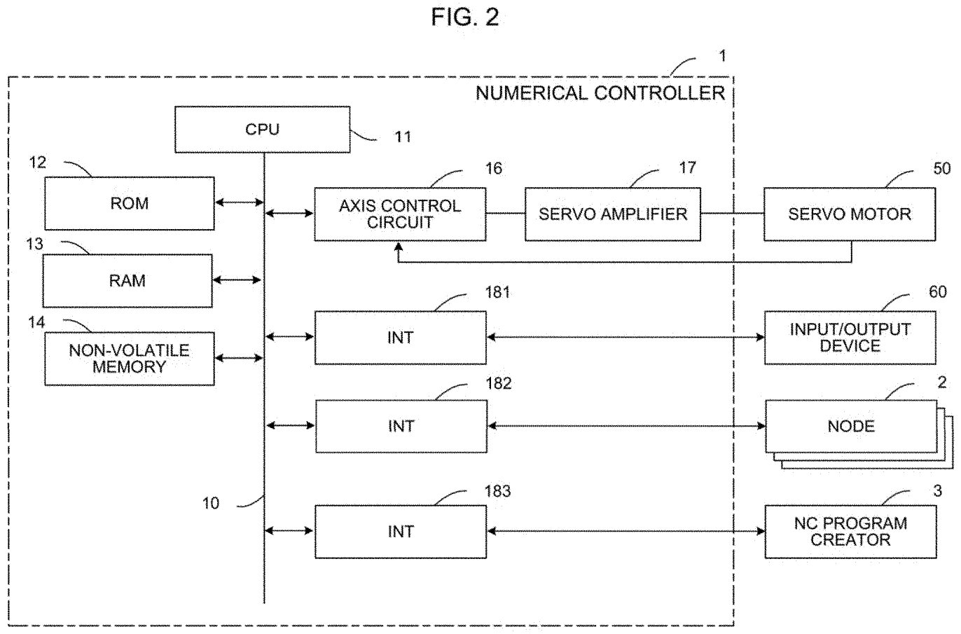

FIG. 2 is a hardware configuration diagram schematically illustrating principal portions of a numerical controller 1.

The numerical controller 1 is a device that controls industrial machinery including a machine tool. The numerical controller 1 includes a CPU 11, a ROM 12, a RAM 13, a non-volatile memory 14, a bus 10, an axis control circuit 16, a servo amplifier 17, an interface 181, an interface 182, and an interface 183. The numerical controller 1 is connected to a servo motor 50, an input/output device 60, nodes 2, and an NC program creator 3.

The CPU 11 is a processor that wholly controls the numerical controller 1. The CPU 11 retrieves a system program stored in the ROM 12 through the bus 10 and controls the entire numerical controller 1 in accordance with the system program.

The ROM 12 has system programs that have been stored in advance to execute, for example, various kinds of control of the industrial machinery. The RAM 13 temporarily stores temporary calculation data or display data, data and programs inputted by an operator through the input/output device 60, data received from the nodes 2, and the like.

The non-volatile memory 14 maintains the state of memory using, for example, a battery (not shown) for memory backup even when the power of the numerical controller 1 is shut off. The non-volatile memory 14 stores data and programs inputted from the input/output device 60, data received from the nodes 2, and the like. The programs and data stored in the non-volatile memory 14 may be loaded into the RAM 13 at the time of execution or use.

The axis control circuit 16 controls an operating axis of the industrial machinery. The axis control circuit 16 receives a commanded amount of travel for the axis outputted from the CPU 11, and outputs a motion command for the operating axis to the servo amplifier 17.

The servo amplifier 17 receives the motion command for the axis outputted from the axis control circuit 16 and drives the servo motor 50. The servo motor 50 is driven by the servo amplifier 17 to move the operating axis of the industrial machinery. The servo motor 50 typically has a built-in position and speed detector. The position and speed detector outputs a position and speed feedback signal. This signal is fed back to the axis control circuit 16. Thus, position and speed feedback control is achieved.

It should be noted that FIG. 2 only illustrates one axis control circuit 16, one servo amplifier 17, and one servo motor 50, but actually the same numbers of axis control circuits 16, servo amplifiers 17, and servo motors 50 as the number of axes of the industrial machinery to be controlled are prepared.

The input/output device 60 is a data input/output device including a display, hardware keys, and the like, which is typically a control panel. The input/output device 60 shows information received from the CPU 11 through the interface 181 on a display. The input/output device 60 passes a command, data, or the like inputted from the hardware keys or the like to the CPU 11 through the interface 181.

The nodes 2 are one or more information processing devices located on a network that can be accessed from the numerical controller 1. Each node 2 maintains various related files. The node 2 outputs a related file in response to a request received from the CPU 11 through the interface 182. The related file is passed to the CPU 11 through the interface 182.

The NC program creator 3 is a device that creates a machine control NC program. An NC program created by the NC program creator 3 is passed to the CPU 11 through the interface 183.

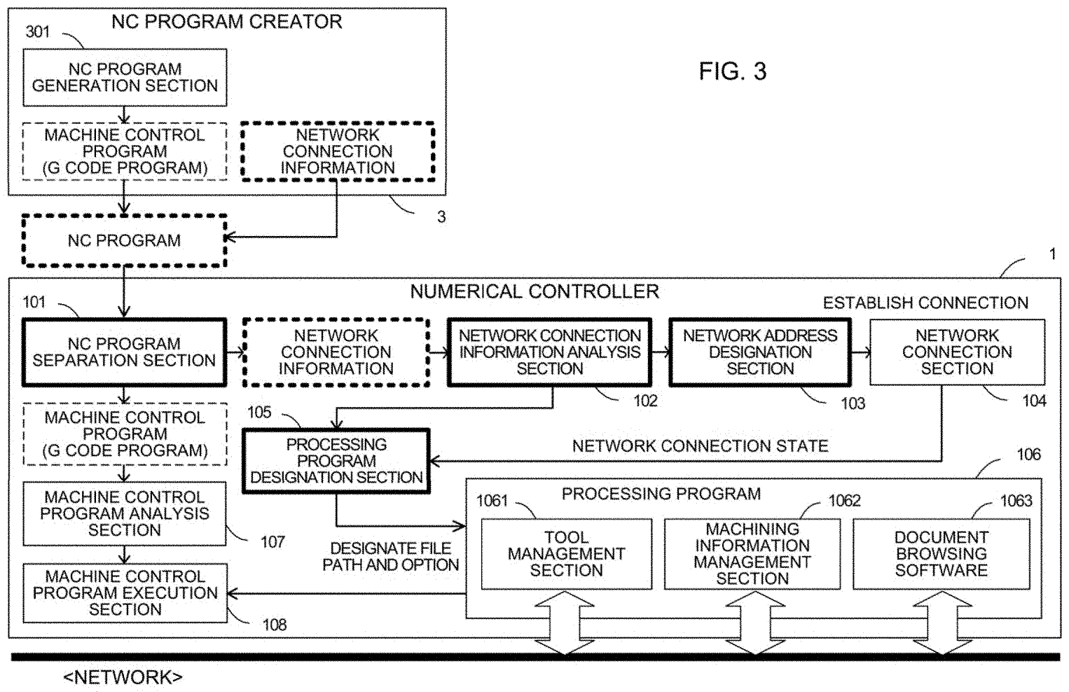

FIG. 3 is a block diagram schematically illustrating a functional configuration of an information processing system 100 including the numerical controller 1.

In FIG. 3, elements drawn by solid lines are processing sections, and elements drawn by dotted lines are data. In particular, elements drawn by bold lines are characteristic components of the present invention. The information processing system 100 typically includes the numerical controller 1, one or more nodes 2, and the NC program creator 3.

The NC program creator 3 includes an NC program generation section 301. The NC program generation section 301 generates and outputs an NC program specific to the present invention that contains a machine control program typically written in G code or the like and network connection information.

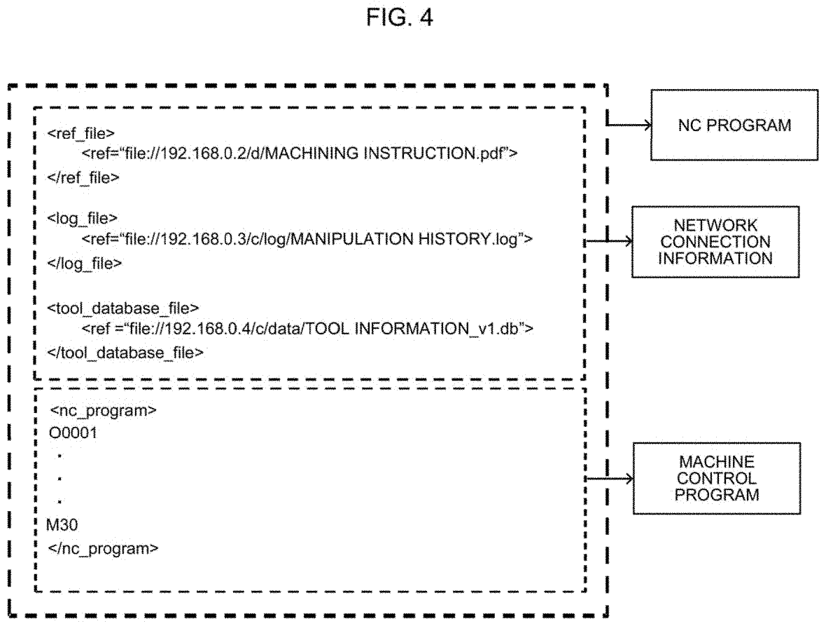

One example of an NC program generated by the NC program generation section 301 is illustrated in FIG. 4.

This NC program is a single file that contains a block containing network connection information and a block containing a machine control program. Each block is structured with characteristic tags.

In the example in FIG. 4, tags <nc_program> and </nc_program> are tags for defining a machine control program. A conventional general NC program, that is, a machine control program written in G code or the like, is placed between these tags. It should be noted that the contents, the generation method, and the like of the machine control program are publicly known and therefore will not be described in detail.

The example in FIG. 4 includes, in addition to the above, various tags for defining the locations of related files on the network. The network connection information is configured using these tags. For example, tags <ref_file> and </ref_file> are tags for defining the location of a reference file (file to be browsed) on the network. Tags <log_file> and </log_file> are tags for defining the location, on the network, of a log file that is referenced and written to by the numerical controller 1. Tags <tool_database_file> and </tool_database_file> are tags for defining the location of a tool information database file on the network. A tag <ref= . . . > is placed between these tags described above, wherein the network address of the node at which the file is located and the file path are written in the portion indicated by “ . . . ”.

The network connection information may include, in addition to the above-described network address and file path, software (to be executed on the numerical controller 1) for executing the file and any information such as software execution options, for example.

The above-described information structure is just an example, and the present invention is not limited to this. The NC program may have any specific structure as long as the NC program includes a machine control program and network connection information. For example, the NC program may be generated by writing network connection information directly into a machine control program in a structured syntax. Alternatively, the NC program may have network connection information written as property information of a file of a machine control program. Alternatively, the NC program may include two or more files including a file containing a machine control program and a file containing network connection information. In the case where the NC program includes two or more files, a file containing a machine control program and a file containing network connection information can be associated with each other using links, operation rules, or the like set inside or outside the files.

As illustrated in FIG. 3, the numerical controller 1 further includes an NC program separation section 101, a network connection information analysis section 102, a network address designation section 103, a network connection section 104, a processing program designation section 105, a processing program 106, a machine control program analysis section 107, and a machine control program execution section 108.

The NC program separation section 101 analyzes the NC program generated by the NC program generation section 301, and separates the NC program into two information elements, that is, the machine control program and the network connection information. The NC program separation section 101 passes the separated network connection information to the network connection information analysis section 102 and passes the separated machine control program to the machine control program analysis section 107.

The network connection information analysis section 102 analyzes the network connection information, and extracts the network addresses of nodes at which related files are located, the file paths, software for executing the files, software execution options, and the like. Of these, information necessary for acquiring the related files are passed to the network address designation section 103. Moreover, information necessary for executing the acquired related files is passed to the processing program designation section 105.

The network address designation section 103 generates information necessary for network connection for acquiring the related files based on the network addresses and the file paths extracted by the network connection information analysis section 102.

The network connection section 104 negotiates with a connecting destination node based on a predetermined communication protocol using the information generated by the network address designation section 103 to establish a connection.

The processing program designation section 105 activates the software extracted by the network connection information analysis section 102, if necessary, with execution options designated. This activates the processing program 106. The processing program designation section 105 passes the network addresses and the file paths of the related files to the activated software.

The processing program 106 is an application program that is executed on the numerical controller 1, and is a software capable of executing the related files. For example, a tool management section 1061 that manages tool information using a database file containing the tool information, a machining information management section 1062 that performs machining analysis using a machining information file, and document browsing software 1063 for browsing drawing files of CAD drawings and the like and document files of machining instructions and the like are activated as the processing program 106. The processing program 106 sends a file acquisition request to the network addresses and the file paths received from the processing program designation section 105 in accordance with a communication method established by the network connection section 104. Upon receiving a related file from a node, the processing program 106 executes a process using the related file.

The number of nodes to which the processing program 106 is connected is not limited. The processing program 106 can connect to each node designated in the network connection information for each piece of software.

The machine control program analysis section 107 analyzes a machine control program by a publicly known technique, and outputs machining instructions. The machine control program execution section 108 controls a drive axis of an industrial machinery in accordance with the machining instructions outputted by the machine control program analysis section 107 to execute machining.

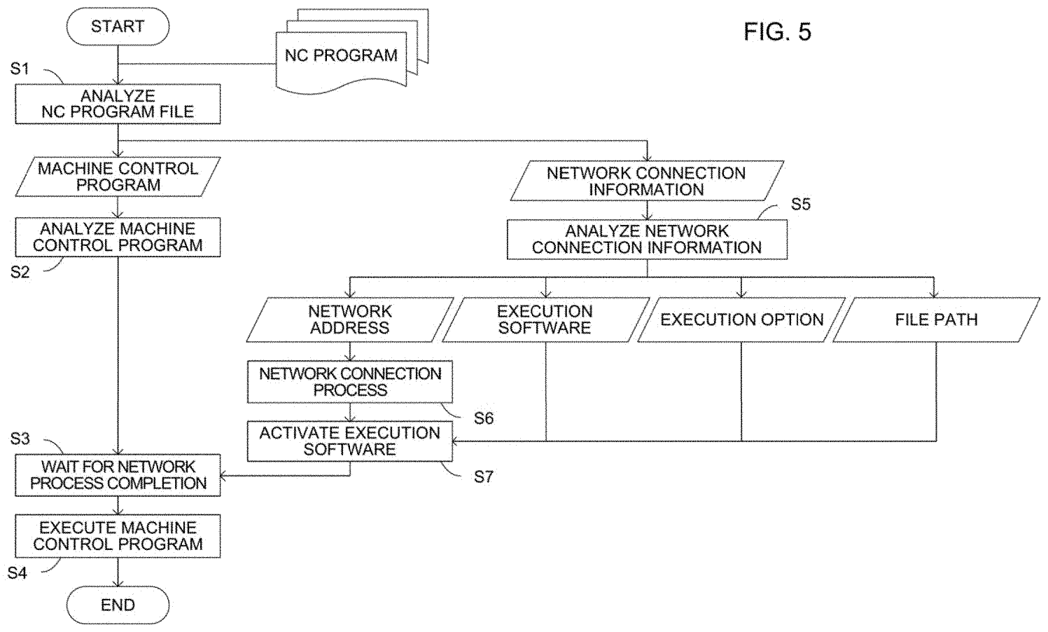

The operation of the numerical controller 1 will be further described with reference to the flowchart in FIG. 5.

Step S1: The NC program separation section 101 analyzes an NC program and separates the NC program into a machine control program and network connection information. Hereinafter, the processing in step S2 concerning the machine control program and the processing from step S5 to step S7 concerning the network connection information are appropriately executed in parallel.

Step S2: The machine control program analysis section 107 analyzes the machine control program and outputs machining instructions.

Step S3: Preferably, the numerical controller 1 waits for execution software (explained in step S7) to acquire a related file. Upon completion of the related file, the program proceeds to step S7.

Step S4: The machine control program execution section 108 controls the drive axis of the industrial machinery in accordance with the machining instructions to execute machining.

Step S5: The network connection information analysis section 102 analyzes the network connection information, and extracts the network address of the node at which the related file is located, the file path, software for executing the file, software execution options, and the like.

Step S6: The network address designation section 103 generates information necessary for network connection based on the extracted network address and file path. The network connection section 104 negotiates with the connecting destination node to establish a connection.

Step S7: The processing program designation section 105 activates the software with execution options designated on the numerical controller 1, and passes the network address and the file path of the related file to the activated software. The processing program 106 connects to the node at which the related file is located, acquires the related file, and starts processing using the related file.

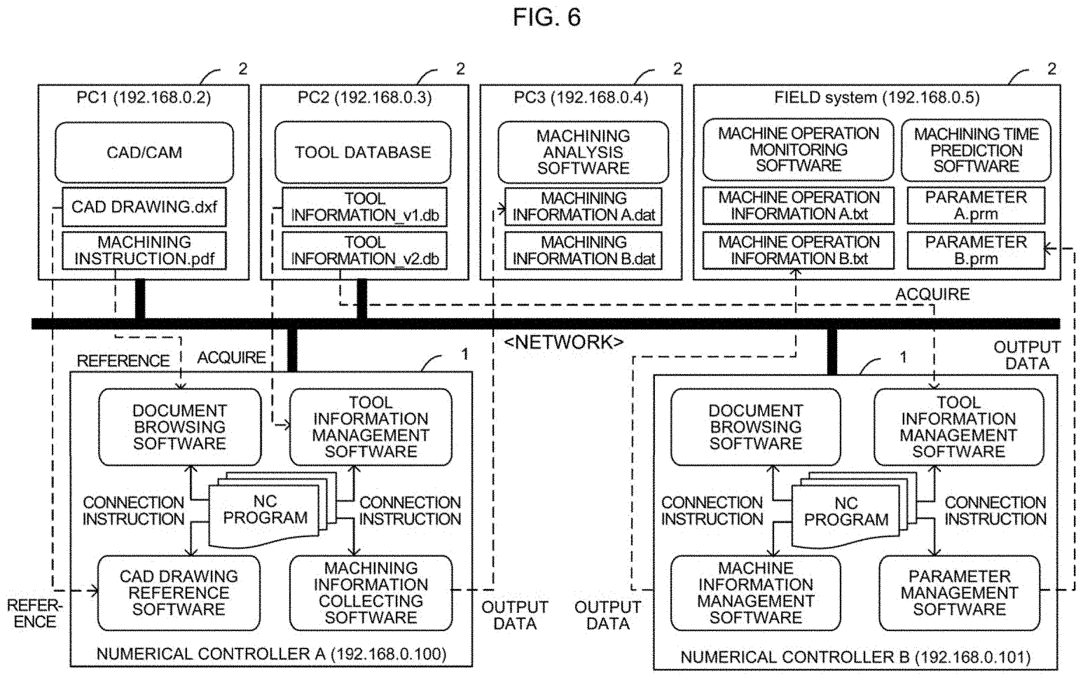

FIG. 6 is a diagram illustrating one modified example of the numerical controller 1. The above-described embodiment (FIG. 3) is an example in which the information processing system 100 includes one numerical controller 1. However, the present invention is not limited to this. The information processing system 100 may include two or more numerical controllers 1 (numerical controller A and numerical controller B in FIG. 6). Moreover, there is no upper limit to the number of nodes 2, and any number of nodes 2 can be added to the information processing system 100 (FIELD SYSTEM in FIG. 6). In the above-described embodiment, each node 2 manages a single kind of information. However, the present invention is not limited to this. One node may manage two or more kinds of related files (FIELD SYSTEM in FIG. 6, which manages machine operation information and parameters). Moreover, there is no limitation to the kind of information that each node deals with. Each node can maintain, as a related file, any information that the numerical controller 1 can deal with in the software.

The above-described embodiment may be appropriately modified without departing from the spirit of the present invention. For example, the above-described embodiment is an example in which the numerical controller 1 acquires related files and the related files are used on the numerical controller 1. However, the present invention is not limited to this. The numerical controller 1 may directly edit, on a node, the contents of a related file written in the network connection information. Typically, this configuration is suitable for the case where an addition, an update, and the like of data are made to a database file and a log file.

Moreover, in the above-described embodiment, file execution software is activated at a predetermined time. However, the present invention is not limited to this. The activation time of file execution software may be freely controlled. For example, network connection information is written in the machine control program in the NC program. In this case, the numerical controller 1 executes the machine control program from the top step by step and, when a portion where the network connection information is written is reached, activates the file execution software. Thus, the numerical controller 1 can execute processing, such as calling a related file, outputting a log to an external node, and acquiring and displaying a machining instruction and CAD data, at a freely-selected time during machining.

Moreover, the above-described embodiment assumes that the network connection information includes the addresses of the nodes on the network and that the related files are located on the network. However, the present invention is not limited to this. The related files may be located inside the numerical controller 1. In this case, the network connection information does not necessarily need to include the network addresses of the nodes but only needs to include at least file paths.

Moreover, in the above-described embodiment, information that the numerical controller 1, for example, references and updates based on the network connection information is referred to as related files. However, such information does not necessarily need to be data in a file format. The present invention can be generally applied to information in any format.

The present embodiment has significant technical effects, such as the following:

1) The numerical controller 1 can accurately, for example, reference and update related files (files of CAD data, a tool database, and the like on which the creation of an NC program is based, a document file of a machining instruction, and the like) scattered on a network using network connection information written in an NC program in advance without taking much time. Accordingly, operator's working time, human errors, and the like can be reduced.

2) Since the numerical controller 1 can directly edit a file on a node, data relating to machining can be easily collected on the node side. For example, by writing, into the network connection information in the NC program, the location where log data is stored and the location where machining states are recorded, data relating to machining can be easily collected without particularly requiring any connecting work and the like on the numerical controller 1 side and the node side.

3) Even when an addition of a node or a change of the network address of a node becomes necessary, these can be dealt with by changing the NC program. This eliminates the necessity to perform work such as changing individual settings of the numerical controller 1.

4) Since connection to the network is automatically established, working costs required to connect to the node in prior art techniques are greatly reduced. Accordingly, distributed management of various data relating to the numerical controller 1 and machining becomes easy.

5) Since the NC program can make a request to activate any file execution software, the types of files and data to be dealt with are not limited.

1. A numerical controller comprising:
a machine control program execution section for performing machining in accordance with a machine control program;
a network connection section for establishing a connection to a connecting destination node written in network connection information; and
a processing program designation section for activating a processing program for accessing information relating to the machining located at the connecting destination node, wherein
the machine control program and the network connection information are treated as a pair.

2. The numerical controller according to claim 1, further comprising:
an NC program separation section for analyzing an NC program containing the machine control program and the network connection information and for separating the NC program into the machine control program and the network connection information.

3. The numerical controller according to claim 1, wherein the network connection information is described, as property information, in an NC program file in which the machine control program is described, and wherein
the numerical controller further comprises an NC program separation section for analyzing the NC program file and for separating the NC program file into the machine control program and the network connection information.
